(19) United States
(12) Patent Application Publication
(10) Pub. No.: US 2010/0026691 A1
(43) Pub. Date: Feb. 4, 2010

(54) METHOD AND SYSTEM FOR PROCESSING GRAPHICS DATA THROUGH A SERIES OF GRAPHICS PROCESSORS

(76) Inventor: Ming Yan, Shenzhen (CN)

Correspondence Address: PATTERSON & SHERIDAN, L.L.P., 3040 POST OAK BOULEVARD, SUITE 1500, HOUSTON, TX, 77056, US

(21) Appl. No.: 12/242,619

(22) Filed: Sep. 30, 2008

(30) Foreign Application Priority Data
Aug. 1, 2008 (CN) 200810145512.1

(51) Int. Cl. G06F 15/16

(52) U.S. Cl. 345/502

(57) ABSTRACT

One embodiment of the present invention sets forth a computer device that comprises a central processing unit, a system memory, a system interface coupled to the central processing unit, wherein the system interface includes at least one connector slot, and a high-performance graphics processing system coupled to the connector slot of the system interface. The high-performance graphics processing system further comprises a plurality of graphics processing units that includes a first graphics processing unit coupled to a set of first data lanes of the connector slot from which the multiprocessor graphics system receives data to process, and a second graphics processing unit coupled to a set of second data lanes of the connector slot through which the multiprocessor graphics system outputs processed data.

### CROSS-REFERENCE TO RELATED APPLICATIONS

This application claims the benefit of People's Republic of China Application No. 200810145512.1, filed on Aug. 1, 2008 and having Atty. Docket No. NVDA/SZ-08-0020-CN.

### BACKGROUND OF THE INVENTION

1. Field of the Invention

The present invention relates to a graphics processing systems, and more particularly, to a method and system for processing graphics data through a series of graphics processors.

2. Description of the Related Art

Unless otherwise indicated herein, the approaches described in this section are not prior art to the claims in this application and are not admitted to be prior art by inclusion in this section.

An increasing number of commercialized computer devices incorporate graphics-dedicated processing systems. In order to increase the processing throughput of the graphics system, multiple graphics processors may be provided in the graphics system. FIG. 1 is a simplified block diagram of a conventional graphics processing system 100 incorporating multiple graphics processors. The graphics processing system 100 includes a first graphics card 102 having a first graphics processing unit (GPU) 104 coupled to a first local memory 106, and a second graphics card 112 having a second GPU 114 coupled to a second local memory 116. In addition, the first graphics card 102 and second graphics card 112 are coupled to separate expansion slots of a Peripheral Component Interconnect Express (PCIE) system bus 120 that serves as a system interface between each of the first and second graphics card 102 and 112 and a central processing unit (CPU) of the computer system (not shown in FIG. 1).

In the above-described graphics processing system 100, because each graphics card is designed as an independent device that requires a separate connection slot of the PCIE system bus 120, further addition of graphics processing capabilities to the computer system may be limited owing to a limited number of PCIE slots provided for the PCIE system bus 120. Moreover, during operation, the graphics data to process must be duplicated in the two local memories 106 and 116 to enable concurrent processing of the two GPUs 104 and 114. As a result, the memory utilization of the graphics processing system 100 is not efficient.

What is needed in the art is thus a method and system that can process graphics data through multiple graphics processors, and address at least the foregoing issues.

### SUMMARY OF THE INVENTION

The present application describes a method and system for processing graphics data through a series of graphics processors. Specifically, one embodiment of the present invention sets forth a computer device that comprises a central processing unit, a system memory, a system interface coupled to the central processing unit, wherein the system interface includes at least one connector slot, and a high-performance graphics processing system coupled to the connector slot of the system interface. The high-performance graphics processing system further comprises a plurality of graphics processing units that includes a first graphics processing unit coupled to a set of first data lanes of the connector slot from which the multiprocessor graphics system receives data to process, and a second graphics processing unit coupled to a set of second data lanes of the connector slot through which the multiprocessor graphics system outputs processed data.

Another embodiment of the present invention sets forth a method for processing graphics data in a high-performance graphics processing system comprising a plurality of graphics processing units. The method comprises receiving graphics data on a first graphics processing unit in the high-performance graphics processing system that is coupled to a plurality of first data lanes of a connector slot, processing the graphics data through the graphics processing units within the graphics processor system, and outputting all processed graphics data through a second processing unit of the high-performance graphics processing system that is coupled to a plurality of second data lanes of the connector slot.

At least one advantage of the present invention disclosed herein is the ability to integrate multiple GPUs coupled in series into one unitary graphics system that can be connected to a single PCIE connector slot. Compared to the conventional approach, the multiprocessor graphics system of the present invention therefore occupies less expansion slots of the PCIE system bus.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a simplified block diagram illustrating the configuration of a conventional graphics processing system;

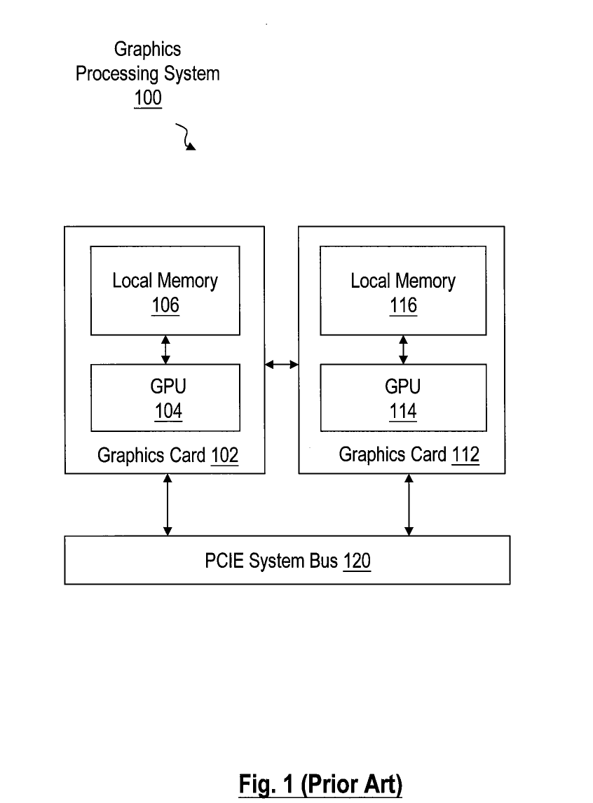

FIG. 2A is a block diagram of a computer device implemented according to one embodiment of the present invention;

FIG. 2B is a schematic diagram illustrating the connection of a multiprocessor graphics system to a PCIE bus connector according to one embodiment of the present invention;

FIG. 3 is a flowchart of method steps implemented by a multiprocessor graphics system to process graphics data, according to one embodiment of the present invention;

FIG. 4 is a flowchart of method steps performed in a pipeline-processing mode of operation according to one embodiment of the present invention; and

FIG. 5 is a flowchart of method steps performed in a parallel-processing mode of operation according to one embodiment of the present invention.

### DETAILED DESCRIPTION

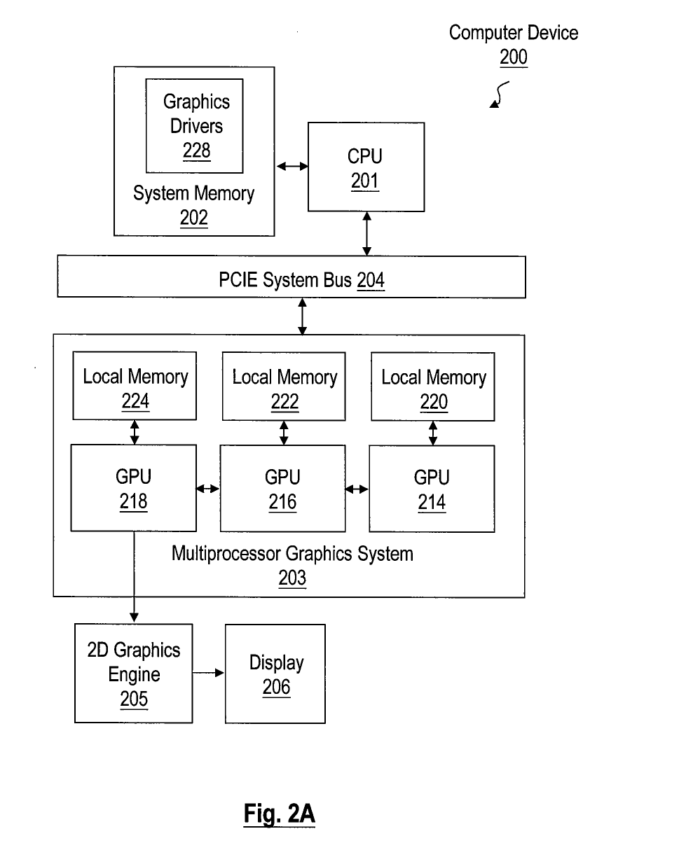

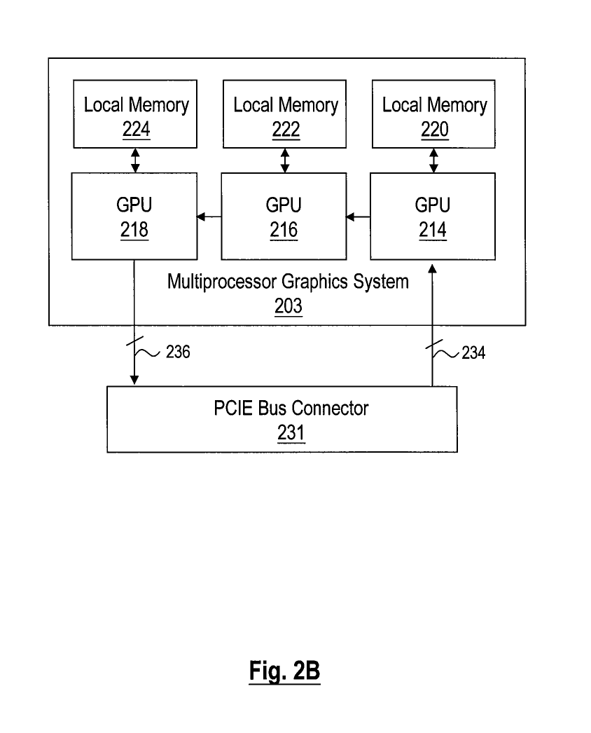

FIG. 2A is a block diagram of a computer device 200 implemented according to one embodiment of the present invention. The computer device 200 includes a central processing unit (CPU) 201, a system memory 202, a multiprocessor graphics system 203, a Peripheral Component Interconnect Express (PCIE) system bus 204, a two-dimension (2D) graphics engine 205, and a display device 206. The PCIE system bus 204 serves as a system interface between the CPU 201 and the multiprocessor graphics system 203. In response to instructions transmitted from the CPU 201, the multiprocessor graphics system 203 is configured to process graphics data that are outputted via the 2D graphics engine 205 for presentation on the display device 206.

In one embodiment, the multiprocessor graphics system 203 is a high-performance processing system that comprises multiple graphics processing units (GPU) 214, 216, and 218 coupled to each other in series, and are capable of operating in a concurrent manner to offer enhanced graphics performance including 3D image features and/or higher graphics processing throughput, e.g., frame rate, fill rate, or the like. Each of the GPU 214, 216, 218 is respectively coupled to a local memory 220, 222, 224 for storing graphics data and program instructions executable on each of the GPU 214, 216, 218. Furthermore, the system memory 202 may store digital information, including system codes, data and programs, such as graphics drivers 228 for the multiprocessor graphics system 203. The graphics drivers 228 are operable on the multiprocessor graphics system 203 to control the various tasks performed by each of the GPU 214, 216, and 218.

Referring again to FIG. 2A, the 2D graphics engine 205 may be a low-performance graphics processing device with basic 2D graphics processing capabilities. In one embodiment, the 2D graphics engine 205 may be operable to prepare graphics data processed by the multiprocessor graphics system 203 for presentation on the display device 206.

FIG. 2B is a schematic diagram illustrating the connection of the multiprocessor graphics system 203 to a PCIE bus connector 231 according to one embodiment of the present invention. In accordance with the PCIE specification, the PCIE bus connector 231 includes a first set of data lanes 234 through which data signals are inputted to the multiprocessor graphics system 203, and a second set of data lanes 236 through which data signals are outputted from the multiprocessor graphics system 203 onto the PCIE system bus. In one embodiment, one of the multiple GPUs in the multiprocessor graphics system 203, such as GPU 214, has PCIE receiver lanes coupled to the first set of data lanes 234, whereas another GPU, such as GPU 218, has PCIE transmitter lanes coupled to the second set of data lanes 236. Furthermore, the PCIE transmitter lanes of the GPU 214 are coupled to the PCIE receiver lanes of the GPU 216, and the PCIE transmitter lanes of the GPU 216 are coupled to the PCIE receiver lanes of the GPU 218. In such connection configuration, all data inputted into the multiprocessor graphics system 203 are initially received on the GPU 214, and processed data are outputted from the multiprocessor graphics system 203 via the GPU 218 coupled to the second set of data lanes 236. Data may be processed by the series of GPUs 214, 216 and 218 according to different modes of operation.

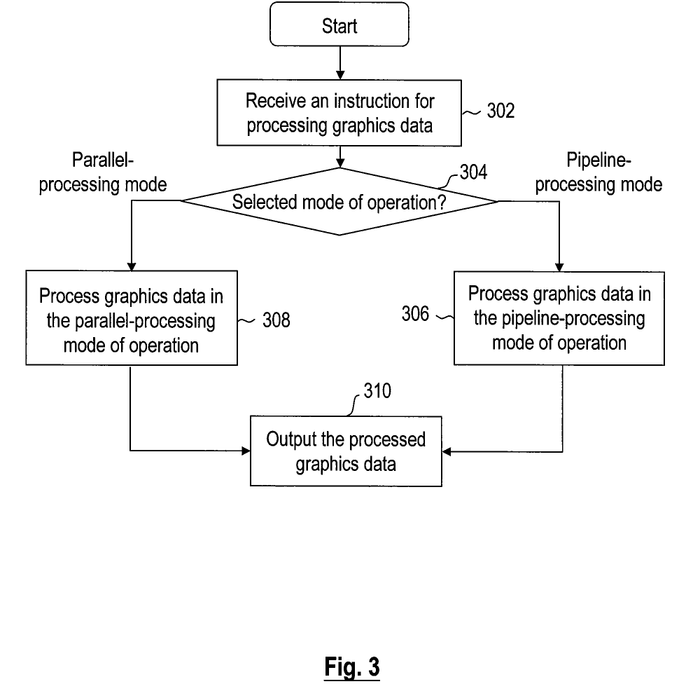

FIG. 3 is a flowchart of method steps implemented by the multiprocessor graphics system 203 to process graphics data, according to one embodiment of the present invention. In initial step 302, the multiprocessor graphics system 203 receives an instruction for processing graphics data. For example, the instruction may be issued by the CPU 202 for rendering graphics data of a frame to be presented on the display device 206. In step 304, a mode of operation for the multiprocessor graphics system 203 is then selected for processing the graphics data. In one embodiment, the graphics data may be processed either according to a pipeline-processing mode of operation in step 306, or according to a parallel-processing mode of operation in step 308. The selected mode of operation for the multiprocessor graphics system 203 may depend on various factors such as the amount of graphics data to process, for example. After the graphics data of the frame to render have all been processed, step 310 is performed to output the processed graphics data from the GPU 218 to either the 2D graphics engine 205, or via the data lanes 236 to the PCIE system bus 204.

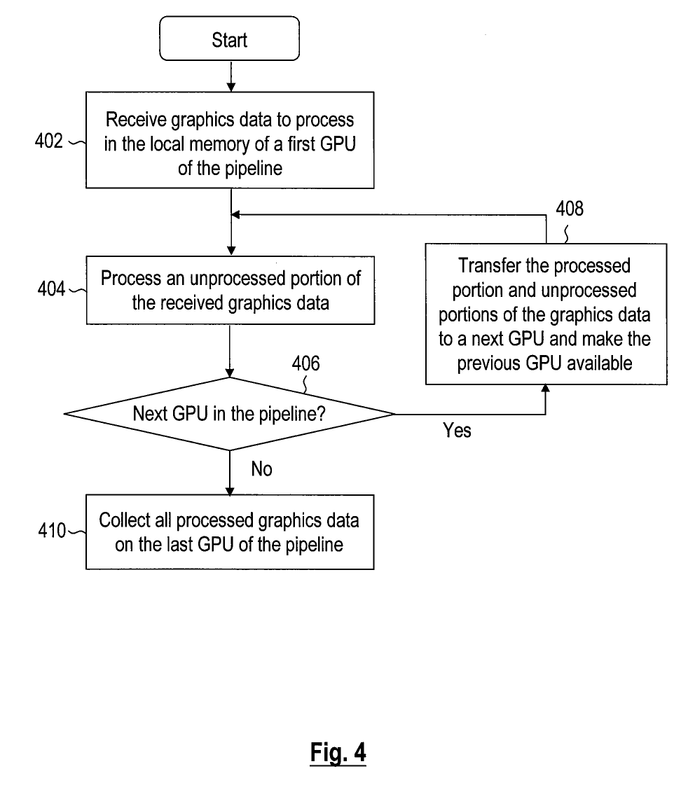

FIG. 4 is a flowchart of method steps performed by the multiprocessor graphics system 203 in a pipeline-processing mode of operation, according to one embodiment of the present invention. In the pipeline-processing mode, the graphics data are processed in through the GPUs 214, 216 and 218 in a pipelined manner. More specifically, suppose that the graphics data are to be processed to render one display frame. In initial step 402, the GPU 214 receives the graphics data to process via the data lanes 234, and stores the graphics data in the local memory 220. In subsequent step 404, the GPU 214 then processes a portion of the received graphics data. In one embodiment, one time slot may be allocated for the GPU 214 to process the portion of graphics data. At the end of the time slot, step 406 is performed to determine whether a next GPU is present in the pipeline. If it is the case, the GPU 214 in step 408 then transfers the processed portion and unprocessed portions of the graphics data to the next GPU (i.e. GPU 216), and then becomes available for processing a next set of graphics data, which may be associated with another rendering instruction, e.g. for rendering a second frame. For each following GPU, i.e. GPU 216 and 218, steps 404-408 are similarly applied in a sequential manner to process unprocessed portions of the graphics data. In step 410, the last GPU, i.e. GPU 218, hence stores all the processed graphics data, and is then able to output all the processed graphics data either to the 2D graphics engine 205, or via the data lanes 236 to the PCIE system bus 204.

In the pipeline-processing mode of operation, multiple frames thus may be processed concurrently along the pipeline of GPUs, which yields a higher graphics processing throughput. Moreover, the memory utilization may be more efficient as all the graphics data do not need to be duplicated in each local memory during operation.

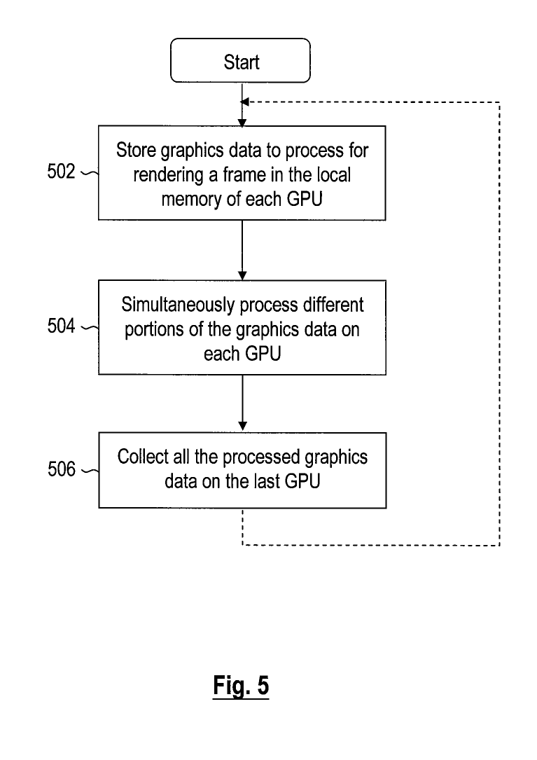

FIG. 5 is a flowchart of method steps performed by the multiprocessor graphics system 203 in a parallel-processing mode of operation, according to one embodiment of the present invention. In the parallel-processing mode, the graphics data are processed concurrently among the different GPUs. For example, suppose that a set of graphics data are to be processed to render one display frame. In initial step 502, the same set of graphics data to process is stored in the local memory of each GPU, e.g. local memory 220, 222 and 224 of GPU 214, 216 and 218. In step 504, each of the GPU 214, 216 and 218 then processes a different portion of the set of graphics data. In step 506, all the processed portions of graphics data are then collected and combined on the GPU 218 to form the rendered frame, which is then ready for output either to the 2D graphics engine 205, or via the data lanes 236 to the PCIE system bus 204. Once all the graphics data have been processed, steps 502-506 may then be repeated to process another set of graphics data to render another display frame.

As has been described, at least one advantage of the present invention is the ability to integrate multiple GPUs into one unitary graphics system that can be coupled to a single PCIE connector slot. Compared to the conventional approach, the multiprocessor graphics system of the present invention therefore occupies less expansion slots of the PCIE system bus. In addition, the multiprocessor graphics system is capable of processing data in a parallel-processing or pipeline-processing mode of operation according to the performance needs. Utilization of the capacities of the graphics system can thus be more efficient.

The above description illustrates various embodiments of the present invention along with examples of how aspects of the present invention may be implemented. The above examples, embodiments, instruction semantics, and drawings should not be deemed to be the only embodiments, and are presented to illustrate the flexibility and advantages of the present invention as defined by the following claims.

We claim:

1. A computer device comprising:
a central processing unit;
a system memory;
a system interface coupled to the central processing unit, wherein the system interface includes at least one connector slot; and
a high-performance graphics processing system coupled to the connector slot of the system interface, wherein the high-performance graphics processing system comprises a plurality of graphics processing units comprising:
a first graphics processing unit coupled to a set of first data lanes of the connector slot from which the multiprocessor graphics system receives data to process, and
a second graphics processing unit coupled to a set of second data lanes of the connector slot through which the multiprocessor graphics system outputs processed data.

2. The computer device of claim 1, wherein the high-performance graphics processing system comprises a third graphics processing unit coupled between the first and second graphics processing unit.

3. The computer device of claim 1, wherein the system interface includes a Peripheral Component Interconnect Express (PCIE) bus.

4. The computer device of claim 1, further comprising a low-performance graphics processing system coupled between the high-performance graphics system and a display device.

5. The computer device of claim 4, wherein the low-performance graphics processor system is configured to receive processed graphics data from the second processing unit for presentation on the display device.

6. The computer device of claim 4, wherein the high-performance graphics processing system is configured to process graphics data either in a pipeline-processing mode of operation or a parallel-processing mode of operation.

7. The computer device of claim 6, wherein the high-performance graphics processing system in the pipeline-processing mode is configured to:
receive graphics data of a first frame to render on the first graphics processing unit;
process a portion of the graphics data on the first graphics processing unit;
transmit an unprocessed portion of the graphics data or the entire graphics data to another graphics processing unit; and
collect the processed portion of the graphics data on the second graphics processing unit.

8. The computer device of claim 7, wherein the first graphics processing unit is configured to receive graphics data of a second frame to render and to process after the portion of graphics data of the first frame has been processed.

9. The computer device of claim 6, wherein the high-performance graphics system in the parallel-processing mode is configured to:
duplicate graphics data of a first frame to render the graphics data of the first frame on each of the plurality of graphics processing units;
concurrently process a different portion of the graphics data on each of the plurality of graphics processing units; and
collect all the processed portions of graphics data on the second graphics processing unit.

10. The computer device of claim 9, wherein the high-performance graphics system is configured to receive graphics data of a second frame to render after the first frame has been entirely processed.

11. A method for processing graphics data in a high-performance graphics processing system comprising a plurality of graphics processing units, the method comprising:
receiving graphics data on a first graphics processing unit in the high-performance graphics processing system that is coupled to a plurality of first data lanes of a connector slot;
processing the graphics data through the graphics processing units within the graphics processor system; and
outputting all processed graphics data through a second processing unit of the high-performance graphics processing system that is coupled to a plurality of second data lanes of the connector slot.

12. The method of claim 11, wherein the step of processing the graphics data through the graphics processing units is performed either in a pipeline-processing mode or a parallel-processing mode.

13. The method of claim 12, wherein the step of processing the graphics data in the pipeline-processing mode comprises:
receiving graphics data of a first frame to render on the first graphics processing unit;
processing a portion of the graphics data on the first graphics processing unit;
transmitting an unprocessed portion of the graphics data to another one of the graphics processing units; and
collecting all the processed portions of the graphics data on the second graphics processing unit.

14. The method of claim 13, further comprising receiving graphics data of a second frame to render on the first graphics processing unit after the portion of graphics data of the first frame has been processed.

15. The method of claim 12, wherein the step of processing the graphics data in the parallel-processing mode comprises:
duplicating graphics data of a first frame to render on each of the graphics processing units;
concurrently processing a different portion of the graphics data on each of the graphics processing units; and
collecting all the processed portions of the graphics data on the second graphics processing unit.

16. The method of claim 15, further comprising receiving graphics data of a second frame to render on the first graphics processing unit after the first frame has been entirely processed.

17. The method of claim 11, wherein the connector slot includes a Peripheral Component Interconnect Express (PCIE) connector slot.

18. The method of claim 11, further comprising outputting all processed graphics data from the second processing unit to a low-performance graphics processing system coupled between the high-performance graphics processing system and a display device.

19. The method of claim 18 wherein the low-performance graphics processing system is configured to receive the processed graphics data for presentation on the display device.

20. The method of claim 11 wherein the high-performance graphics processing system comprises a third graphics processing unit coupled between the first and second graphics processing unit.

21. A method for processing graphics data in a high-performance graphics processing system comprising a plurality of graphics processing units coupled to one another, the method comprising:
receiving graphics data of a first frame on a first graphics processing unit of the high-performance graphics processing system;
processing the graphics data through the plurality of graphics processing units according to either a pipeline-processing mode of operation or a parallel-processing mode of operation; and
outputting the processed graphics data of the first frame through a second graphics processing unit of the high-performance graphics processing system;
wherein processing the graphics data according to the pipeline-processing mode of operation comprises:
processing a portion of the graphics data the first graphics processing unit and transmitting the processed portion of the graphics data and an unprocessed portion of the graphics data or the entire graphics data to a next graphics processing unit.

22. The method of claim 21, further comprising receiving graphics data of a second frame to render on the first graphics processing unit after the first graphics processing unit has transmitted the processed portion of graphics data of the first frame to the next graphics processing unit.

23. The method of claim 21, wherein processing the graphics data according to a parallel-processing mode of operation comprises:
duplicating graphics data of the first frame to render on each of the graphics processing units;
concurrently processing a different portion of the graphics data on each of the graphics processing units; and
collecting all the processed portions of the graphics data on the second graphics processing unit.

24. The method of claim 23, further comprising receiving graphics data of a second frame to render on the first graphics processing unit after the first frame has been entirely processed through the plurality of graphics processing units in the parallel-processing mode.

25. The method of claim 21, wherein the high-performance graphics processing system is coupled to a connector slot.

26. The method of claim 25, wherein the connector slot includes a Peripheral Component Interconnect Express (PCIE) connector slot.

27. The method of claim 26, wherein the step of receiving the graphics data of the first frame on the first graphics processing unit is performed via a plurality of first data lanes of the connector slot that are coupled to the first graphics processing unit.

28. The method of claim 26, wherein the step of outputting the processed graphics data of the first frame through a second graphics processing unit is performed via a plurality of second data lanes of the connector slot that are coupled to the second graphics processing unit.

29. The method of claim 26, wherein the high-performance graphics processing system further comprises a third graphics processing unit coupled between the first and second graphics processing unit, wherein the third graphics processing unit is configured to receive graphics data to process from the first graphics processing unit.

30. The method of claim 21, wherein the step of outputting the processed graphics data of the first frame through the second graphics processing unit further comprising transferring the processed graphics data to a low-performance graphics processing system coupled between the high-performance graphics processing system and a display device.
